(19) United States
(12) Patent Application Publication
(10) Pub. No.: US 2025/0362754 A1
(43) Pub. Date: Nov. 27, 2025

(54) METHOD OF HAPTIC RENDERING VIA MULTIPLE VIRTUAL COUPLING SYSTEMS WITH ENERGY CONSISTENCY

(71) Applicant: BEIHANG UNIVERSITY, Beijing (CN)

(72) Inventors: Hongyu WU, Beijing (CN); Lei HE, Beijing (CN); Shuai LI, Beijing (CN); Aimin HAO, Beijing (CN); Yang GAO, Beijing (CN)

(73) Assignee: BEIHANG UNIVERSITY, Beijing (CN)

(21) Appl. No.: 18/762,655

(22) Filed: Jul. 3, 2024

(30) Foreign Application Priority Data
May 23, 2024 (CN) 2024106497844

(51) Int. Cl. G06F 3/01; G06T 17/20

(52) U.S. Cl. CPC G06F 3/016; G06T 17/20; G06T 2210/21; G06T 2210/41

(57) ABSTRACT

The present invention discloses a method of haptic rendering via multiple virtual coupling systems with energy consistency, which relates to the technical field of human-computer interaction in virtual reality and realizes six-degree-of-freedom force synthesis of complex operations, such as pressing and inserting, in the process of large-deformation between a tool and a softbody, which relates to the field of human-computer interaction in virtual reality. In the simulation scenario, the simulation system for each object contains two parts: the graphical part and the physical part, and the two parts are linked by means of virtual coupling. In addition, the mutual contact force between the tool simulation system and the softbody simulation system has the characteristic of consistent energy, which reduces the computational redundancy between two systems with different frequency, ensuring the real-time and robustness of deformation simulation under the condition of uncertain interaction.

### TECHNICAL FIELD

The present invention relates to the technical field of human-computer interaction in virtual reality, and more particularly to a method of haptic rendering via multiple virtual coupling systems with energy consistency.

### BACKGROUND ART

The frequency requirement for a human to feel fluent in haptic is higher than the frequency requirement for a human to feel fluent in visual, for example, a 60 Hz image output can be fluent, while at least 500 Hz in haptic is required to not feel significant jitter. Since the amount of calculation required for softbody deformation is generally greater and the demand for output frequency is lower; the amount of calculation required for feedback force output is usually small, but the demand for output frequency is high. In order to realize the haptic feedback interaction between humans and objects in a virtual environment, the existing mainstream implementation method divides the interaction process into two parts: softbody deformation simulation and feedback force calculation.

Projective Dynamics is a commonly used softbody deformation simulation framework. Softbody deformation can be understood as the process of gradually updating the model vertex. Projective Dynamics constructs constraints between model vertices and updates vertex positions by minimizing the energy defined by the constraints, thus achieving the effect of softbody deformation.

The solution of constraints can be divided into two steps: local constraint solution and global constraint solution. Local constraint solving calculates the energy gradient at the associated vertex for a single constraint (used to update the vertex position). The global solution combines the results of multiple local constraint solutions to obtain the updated vertex positions.

Projective Dynamics uses a Jacobi iterative solver to solve an intermediate solution among a plurality of constraints that satisfies all constraints as much as possible, thereby avoiding the problem of the final result jumping between several constraints. The Projective

Dynamics method uses projection to project vertex positions onto a constrained zero-potential hyperplane. And taking the distance between the vertex and the point of zero-potential energy surface projection as a measure of the constraint. The definition of constraint energy has the following form:

$${E}_{q} = {\sum }_{i} \frac{{w}_{i}}{2} {‖ {A}_{i} {S}_{ι} q - {B}_{i} {p}_{i} ‖}_{F}^{2} + {δ}_{{C}_{i} ( {p}_{i} )}$$

where, wᵢ is the stiffness coefficient of constraint, Aᵢ and Bᵢ are the system parameter matrices corresponding to constraint i, and Sᵢ is the selection matrix for selecting vertices related to the current constraint. The constraint energy is the shortest Euclidean distance metric that projects the vertex to the zero-potential energy surface of the constraint energy, and the minimization of the constraint energy is the optimization goal of solving the constraint. By projecting the vertices to be optimized onto the constrained zero-potential energy manifold, most of the nonlinear part of the constraint is left on the constrained zero potential energy surface manifold, so that the method can express the energy of the constraint in a very simple square distance way. There are multiple constraint energies E on a softbody vertex, and the total energy of multiple constraints can be obtained by accumulating local constraint energies measuring the distance between current point position and projection point pᵢ.

After accumulating multiple local solution energy, the final vertex position is obtained by the global solution. The global solution can be expressed by the following formula:

$$( \frac{M}{{h}^{2}} + {\sum }_{i} {w}_{i} {S}_{\dot{ĩ}}^{T} {A}_{i}^{T} {A}_{i} {S}_{i} ) q = \frac{M}{{h}^{2}} {s}_{n} + {\sum }_{i} {w}_{i} {S}_{i}^{T} {A}_{i}^{T} {B}_{i} {p}_{i}$$

where, M is the system mass matrix and q is the unknown quantity. The updated vertex position of the softbody can be obtained by solving the above linear equations, and the vertex displacement can achieve the effect of softbody deformation. Such a local-global solution method can efficiently solve the constraints on vertices. And because of the use of Jacobi iterative method, this constraint solving algorithm can find a compromise solution among multiple constraints, and there will be no local solution jumping back and forth between multiple constraints.

The existing calculation methods of feedback force can be divided into two categories: penalty force calculation method and virtual coupling method.

The penalty force calculation method calculates the force generated by the distance between point and the tool surface for each point that collides with the tool, and finally outputs the resultant force on the virtual tool to the haptic feedback device.

The virtual coupling method maintains a virtual tool pose that does not collide with the object, and the feedback force is calculated by the difference between the virtual tool pose and the physical tool pose.

How to obtain the virtual tool pose without collision with the object is the key to the feedback force calculation method. The main methods are: by solving the quadratic programming problem, the virtual tool pose with an non-penetration object is obtained; the virtual tool pose is gradually updated by solving the force balance equation.

The first type of method is prone to the absence of a reasonable virtual tool pose in a narrow space, resulting in an error in the calculation of feedback force.

The second method is to gradually update the pose of the virtual tool by solving the force balance equation, according to Newton's third law, the force applied by the softbody to the virtual tool is equal to the force applied by the virtual tool to the softbody in the opposite direction, that is, the resultant force of the collision force on the virtual tool and the virtual coupling force is 0. With the movement of the physical tool, the resultant force will no longer be 0, so the pose of the virtual tool is updated, so that the resultant force of the collision force and the virtual coupling force is 0 again. This method can gradually update the pose of the virtual tool in a narrow space, and the output feedback force is relatively stable.

Existing problems: in order to update the shape of the softbody, collision detection with a tool in the virtual space is required, and the part where the collision occurs will be deformed according to the contact state. In order to calculate the feedback force, collision detection between the tool and the colliding object in the virtual space is still required, and the position of the virtual tool is updated according to the result of the collision detection. Since the update frequencies of the softbody deformation end and the haptic feedback end are different, the existing implementation methods will respectively perform collision detection and collision response calculation at the softbody deformation end and the haptic feedback end, resulting in calculation redundancy.

### SUMMARY

The objective of the present invention is to provide a method of haptic rendering via multiple virtual coupling systems with energy consistency, which can process common virtual surgery scenarios in which a tool is inserted into a narrow gap and obtain a stable feedback force output, reduce the computational redundancy between two different frequency systems and improve the computational efficiency by utilizing the consistency of non-penetration energy at the deformation end and the haptic feedback end.

In order to achieve the above objective, the present invention provides a multiple virtual coupling system, comprising a virtual coupling system of tools and a virtual coupling system of softbodies, the virtual coupling system of tools consists of two parts: virtual tools and physical tools, and the virtual coupling system of softbodies consists of two parts: virtual softbodies and physical softbodies.

A method of haptic rendering via multiple virtual coupling systems with energy consistency, comprises the following steps:
S1, in a multiple virtual coupling system, constructing an energy consistency constraint, comprising:
S11, softbody-to-softbody energy consistency constraint;
S12, tool-to-tool energy consistency constraint;
S13, tool-to-softbody energy consistency constraint;
S2, calculating a total constraint energy on the virtual tool to update the virtual tool pose, calculating and outputting a six-degree-of-freedom feedback force using an updated virtual tool pose; and
S3, constructing a shared storage update strategy around the collision information about the haptic feedback end, wherein the haptic feedback end is a process set related to feedback force calculation in a haptic feedback interaction algorithm with energy consistent of a multiple virtual coupling system.

Preferably, in step S11, there will be a collision interaction between the softbodies, the softbody is represented by a sphere tree, and the collision detection and collision response between the softbodies are performed using the sphere tree, the collision detection will build an energy consistency constraint on the ball in collision between the softbodies:

$${E}_{ss} = \frac{{w}_{ss}}{2} {‖ {q}_{sphere} - {p}_{sphere} ‖}_{F}^{2} + δ {C}_{css} ( {p}_{sphere} ) \qquad ( 1 )$$

where, Eₛₛ is a constraint energy generated by the collision between the softbodies, wₛₛ is a energy parameter after the collision between the softbodies set by the user, qₛₚₕₑᵣₑ is a center position of the softbody sphere, pₛₚₕₑᵣₑ is a center position of the softbody sphere that just does not collide after projection, and δC_{css}(Pₛₚₕₑᵣₑ) is an indicator function of the collision between the softbodies;
in the softbody model organized by the sphere tree, each sphere tree node contains multiple softbody vertices, and the collision energy on the sphere tree node is evenly distributed to the tetrahedral vertices contained in the sphere tree node, which is expressed by the following formula:

$${E}_{c t v} = {E}_{s s} / {n}_{t v} \qquad ( 2 )$$

where, E_{ctv} is a collision energy on the sphere tree node allocated on the tetrahedral vertices contained in the sphere tree node, and nₜᵥ is a number of tetrahedral vertices contained in the current sphere tree node.

Preferably, in step S12, the tool interacts with the tool through collision, after the position overlap between the two virtual tools, the energy constraint between the virtual tools is constructed

$${E}_{tt} = \frac{{w}_{t t}}{2} {‖ {X}_{g} - {X}_{pg} ‖}_{F}^{2} + δ {C}_{ctt} ( {X}_{p g} ) \qquad ( 3 )$$

where, Eₜₜ is a constraint energy generated by the collision between the virtual tools, wₜₜ is an energy parameter after the collision between the virtual tools set by the user, X_{g} is the current position of the virtual tool, X_{pg} is a position of the virtual tool that does not collide with the tool after projection, and δC_{ctt}(X_{pg}) is an indicator function of the collision between the virtual tools.

Preferably, in step S13, the energy consistency constraint between the tool and the softbody is used to perform collision detection between the virtual tool and the surface vertex, specifically:
S131, energy consistent softbody and tool haptic feedback interaction;
S132, non-penetration energy on the virtual tool resulting from the intersection of the softbody vertex with the virtual tool position.

Preferably, in step S131, the energy consistent softbody and tool haptic feedback interaction scheme comprises the energy generated by position intersect in softbody deformation, which is expressed as:

$${E}_{cst} = \frac{{w}_{c}}{2} {‖ q - p ‖}_{F}^{2} + δ {C}_{cst} ( p ) \qquad ( 4 )$$

where, w_{c} represents a stiffness coefficient of non-penetration constraint set by the user, and a constraint C_{cst} is a collision constraint between the virtual softbody vertex and the virtual tool, the condition of satisfying the constraint is that the softbody vertex and the virtual tool do not intersect in space, p is a projected position of the vertex q that satisfies the constraint C_{cst}, and δC_{cst}(p) is an indicator function of softbody vertex p that satisfy the non-penetration constraint.

Preferably, in step S132, a non-penetration constraint energy is represented by the following formula:

$${E}_{cts} - \sum \frac{{w}_{c}^{i}}{2} {‖ {X}_{g} - {X}_{pg}^{i} ‖}_{F}^{2} + δ {C}_{cts} ( {X}_{pg}^{i} ) \qquad ( 5 )$$

where, X_{g} is a position of the virtual tool,

$${X}_{pg}^{i}$$

is a position of the virtual tool that is not collided with a vertex i after the projection of the position of the virtual tool, and

$$δ {C}_{cts} ( {X}_{pg}^{i} )$$

is an indicator function of the projected virtual tool.

Preferably, in step S2, the total constraint energy on the virtual tool updates the virtual tool pose calculation comprises the following steps:
the virtual coupling energy on the virtual tool is expressed by the following formula:

$${E}_{vc \_ sat} \frac{{w}_{vc}}{2} = {‖ r e ‖}_{F}^{2} \qquad ( 6 )$$

$$where$$

$${d}_{vc} = ‖ {X}_{h} - {X}_{g} ‖$$

$$e = \frac{{X}_{h} - {X}_{g}}{{d}_{vc}}$$

$$r = \{ \begin{matrix}{k}_{vc} {d}_{vc} & , if {d}_{vc} < {d}_{lin} \\ {F}_{VC \_ MAX} ( 1 - \frac{1}{2} e \text{?} ) & , otherwise\end{matrix} \qquad ( 7 )$$

$$\text{?} \text{indicates text missing or illegible when filed}$$

where, w_{vc} is a virtual coupling weight set by the user, d_{vc} is the distance between the virtual tool and the physical tool, r is a size of the virtual coupling force on the tool, e is a unit vector from the virtual tool to the physical tool, dₗᵢₙ is an interval of the linear change of the virtual coupling force set by the user, Xₕ is a position of the physical tool, F_{VC_MAX} is a maximum virtual coupling force intensity set by the user, k_{vc} is a coefficient of the virtual coupling force set by the user, according to the three kinds of energy defined on the virtual tool, the total constraint energy E on the virtual tool, update the virtual tool pose:

$$E = {E}_{vc \_ sat} + {E}_{cts} + {E}_{t t} . \qquad ( 8 )$$

Preferably, in step S2, the updated virtual tool pose is used to calculate and output the six-degree-of-freedom feedback force, comprising the following steps:
a pose of the virtual tool is expressed as [X_{g}, ω_{g}], and a pose of the physical tool is expressed as [Xₕ, ωₕ], a first item X of the tool pose is the position of the tool, and a second item ω is the pose of the tool, the pose of the virtual tool is updated by the moment balance constraint on the virtual tool, a sum of the resultant force Fₜₒₜₐₗ acting on the virtual tool and a torque Tₜₒₜₐₗ on the virtual tool is specified as

$${F}_{total} = {F}_{c} + {F}_{vc \_ sat} + {F}_{t t} \qquad ( 9 )$$

$${T}_{total} = {T}_{c} + {T}_{vc} + {T}_{tt}$$

where, F_{c} is a contact force generated by the collision between the virtual tool and the virtual softbody, F_{vc_sat} is a virtual coupling force on the virtual tool,

$${F}_{t t} = - \frac{\partial {E}_{t t}}{\partial {X}_{g}}$$

is a contact force generated by the collision between the virtual tools, T_{c} is a contact force torque generated by the collision between the virtual tool and the virtual softbody, T_{vc} is a torque generated by the virtual coupling force, Tₜₜ=t×Eₜₜ is a contact torque generated by the collision between the virtual tools, t is the vector of the grasping point on the virtual tool pointing to the collision point;
because the force on the virtual tool is balanced, the total torque is also balanced, so the optimization goal is:

$${F}_{total}^{new} = {F}_{total} + \frac{\partial {F}_{total}}{\partial {X}_{g}} Δ {X}_{g} + \frac{\partial {F}_{total}}{\partial {ω}_{g}} {Δ ω}_{g} = 0 \qquad ( 10 )$$

$${T}_{total}^{new} = {T}_{total} + \frac{\partial {T}_{total}}{\partial {X}_{g}} Δ {X}_{g} + \frac{\partial {T}_{total}}{\partial {ω}_{g}} {Δ ω}_{g} = 0$$

where

$${F}_{toatal}^{new}$$

is a resultant force of the virtual coupling force and the contact force on the updated virtual tool,

$${T}_{total}^{new}$$

is a resultant torque of virtual coupling moment and contact torque on the updated virtual tool,

$$\frac{\partial {F}_{total}}{\partial {X}_{g}}$$

is a gradient of the resultant force on the virtual tool at the current virtual tool position,

$$\frac{\partial {F}_{total}}{\partial {ω}_{g}}$$

is a gradient of the resultant force on the virtual tool at the current virtual tool attitude,

$$\frac{\partial {T}_{t o t a l}}{\partial {X}_{g}}$$

is a gradient of the resultant torque on the virtual tool at the current virtual tool position,

$$\frac{\partial {T}_{total}}{\partial {ω}_{g}}$$

is a gradient of the resultant torque on the virtual tool at the current virtual tool attitude;
here, to satisfy the force balance and torque balance constraints on the virtual tool, the resultant total force and resultant total torque as optimization objectives are 0;
where, the process of solving the pose update of the virtual tool using the Newton method is expressed by the following formula:

$$[ \begin{matrix}\frac{\partial {F}_{total}}{\partial {X}_{g}} & \frac{\partial {F}_{total}}{\partial {ω}_{g}} \\ \frac{\partial {T}_{total}}{\partial {X}_{g}} & \frac{\partial {T}_{total}}{\partial {ω}_{g}}\end{matrix} ] [ \begin{matrix}Δ {X}_{g} \\ {Δ ω}_{g}\end{matrix} ] = - [ \begin{matrix}{F}_{total} \\ {T}_{total}\end{matrix} ] \qquad ( 11 )$$

solving the system of equations in formula (11) to obtain

$$[ \begin{matrix}Δ {X}_{g} \\ {Δ ω}_{g}\end{matrix} ]$$

for updating the pose of the current virtual tool, where,

$$\frac{\partial {F}_{total}}{\partial {X}_{g}} = - ( \frac{{\partial }^{2} {E}_{vc \_ sat}}{\partial {X}_{g}^{2}} + \frac{{\partial }^{2} {E}_{cts}}{\partial {X}_{g}^{2}} + \frac{{\partial }^{2} {E}_{tt}}{\partial {X}_{g}^{2}} ) \qquad ( 12 )$$

$$\frac{\partial {F}_{total}}{\partial {ω}_{g}} - \frac{\partial {F}_{vc \_ sat}}{\partial {ω}_{g}} + \frac{\partial {F}_{c}}{\partial {ω}_{g}} - \frac{{\partial }^{2} {E}_{tt}}{\partial {ω}_{g}^{2}}$$

$$\frac{\partial {T}_{total}}{\partial {X}_{g}} = \frac{\partial {T}_{vc}}{\partial {X}_{g}} + \frac{\partial {T}_{c}}{\partial {X}_{g}} + \frac{\partial {T}_{tt}}{\partial {X}_{g}}$$

$$\frac{\partial {T}_{total}}{\partial {ω}_{g}} = \frac{\partial {T}_{vc}}{\partial {ω}_{g}} + \frac{\partial {T}_{c}}{\partial {ω}_{g}} + \frac{\partial {T}_{tt}}{\partial {ω}_{g}}$$

after solving (11), the pose of the virtual tool is updated:

$${X}_{g}^{new} ← {X}_{g} + Δ {X}_{g} \qquad ( 13 )$$

$${ω}_{g}^{new} ← update ( {ω}_{g} , {Δ ω}_{g} )$$

$${X}_{g} ← {w X}_{g} + ( 1 + w ) {X}_{g}^{new}$$

$${ω}_{g} ← w {ω}_{g} + ( 1 + w ) {ω}_{g}^{new}$$

where,

$${X}_{g}^{new}$$

is a position of the virtual tool updated by Newton method, update( [symbol] ) is a function of updating the tool pose according to the pose change,

$${ω}_{g}^{new}$$

is the updated virtual tool pose, and w∈[0,1) is a weight of the pose in the last iteration, when the number of iterations exceeds the number set by the user, jump out of the loop and output the six-degree-of-freedom feedback force [−F_{vc_sat}, −T_{vc}] to the haptic feedback device.

Preferably, in step S3, constructing a shared storage update strategy around the collision information about the haptic feedback end, comprising:
in each haptic feedback frame, collision information is generated on each softbody vertex, this collision information includes the non-penetration constraint energy E_{c} generated by the penetration between the tool and the softbody and a gradient information

$$\frac{{\partial }^{2} {E}_{c}}{\partial {X}_{g}^{2}}$$

generated by the constraint solution, the collision energy and gradient information generated by the collision with the tool on the softbody vertex are expressed as follows:

$$\begin{matrix}{E}_{c} = {\sum }_{i = 1}^{p} {E}_{cst}^{i} \\ \frac{{\partial }^{2} {E}_{c}}{\partial {q}^{2}} = - {\sum }_{i = 1}^{p} \frac{{\partial }^{2} {E}_{cst}}{\partial {X}_{g}^{2}}\end{matrix} \qquad ( 14 )$$

the non-penetration constraint energy on the softbody vertex is consistent with the non-penetration constraint energy on the virtual tool, but the gradient of the softbody vertex here is opposite to the gradient direction of the virtual tool here;
in the time of processing a softbody deformation frame, several haptic feedback frames may be finished, therefore, the collision information on the vertices of the softbody is accumulated until the softbody deformation end completes its vertex position update, after vertex position update finished, the accumulated collision information on the vertices is emptied.

Therefore, the present invention uses the above-mentioned methods of haptic feedback interaction based on energy consistent of multiple virtual coupling systems, and the technical effects thereof are as follows:
(1) being able to handle the scenario of insertion of common tools into narrow gaps in virtual surgery and obtain a stable six-degree-of-freedom feedback force;
(2) achieving a higher frequency of surface vertex position update, the virtual tool position obtained is more stable, and the output six-degree-of-freedom feedback force is smoother.
(3) the softbody deformation end uses a higher frequency collision signal to drive the deformation, the collision energy sampling frequency is higher, and the calculation is more accurate.
(4) reducing the calculation cost of collision detection and improving the calculation efficiency.

Further detailed descriptions of the technical scheme of the present invention can be found in the accompanying drawings and examples.

### BRIEF DESCRIPTION OF THE DRAWINGS

FIG. 1 is a schematic diagram of the six-degree-of-freedom haptic feedback interactive system structure of the softbody and the tool;

FIG. 2 is a flow chart of a six-degree-of-freedom feedback force calculation;

FIG. 3 is a schematic diagram of the non-penetration energy transfer from the surface vertices to the tetrahedral vertices.

### DETAILED DESCRIPTION OF THE EMBODIMENTS

The technical solution of the present invention will be further elaborated hereafter in conjunction with accompanying drawings and examples.

Unless otherwise defined, technical or scientific terms used in the present invention are to be given their ordinary meaning as understood by those of ordinary skill in the art to which the present invention belongs.

### Example 1

a multiple virtual coupling system, comprising a virtual coupling system of tools and a virtual coupling system of softbodies. The virtual coupling system of tools consists of two parts: virtual tools and physical tools, and the virtual coupling system of softbodies consists of two parts: virtual softbodies and physical softbodies.

There are two types of objects in the system: one is a tool that users can directly operate, and the other is a softbody that responds to user interaction.

Virtual coupling means to express the user's operation of the tool refers to: virtual tools and physical tools. Virtual tools are tools in the simulation space, and physical tools refer to the location of surgical tools in the real space. Virtual tools interact with physical tools through virtual coupling. In virtual coupling, the virtual tool is constrained by two kinds of energy: the energy constraint from the physical tool and the non-penetration energy constraint from the external collision. The energy constraints on the tool are shown in the virtual coupling energy on the virtual tool.

Virtual coupling means to express softbody refers to: virtual softbody and physical softbody. The softbody in the simulation space is the virtual softbody used for rendering; the physical softbody is used to maintain the physical properties of the softbody, including the volume maintenance of the softbody, the physical deformation of the softbody, etc. The virtual softbody uses triangular mesh, and the physical softbody uses tetrahedral mesh. Virtual coupling is used to communicate between a virtual softbody and a physical softbody, by constructing energy constraints between a virtual softbody and a physical softbody, the position consistency between a virtual softbody and a physical softbody is maintained. The energy constraints on virtual softbodies include: location constraints from the physical softbody, and non-penetration energy constraints from external tools. The virtual coupling energy on the virtual softbody is used to constrain the virtual softbody to the physical softbody. The virtual softbody constraint and the constraint energy on the physical softbody are expressed as follows:

$${E}_{s \_ vc} = \frac{{w}_{s \_ vc}}{2} {‖ {q}_{tri} - {q}_{tet} ‖}_{F}^{2} \qquad ( 1 )$$

where E_{s_vc} is the virtual coupling energy on the softbody, w_{s_vc} is the virtual coupling energy weight on the softbody set by the user, qₜᵣᵢ is the vertex position on the virtual softbody, and qₜₑₜ is the physical softbody vertex position bound by the virtual softbody vertex.

The multiple virtual coupling system proposed by the present invention includes multiple pairs of virtual coupling systems, which can simulate complex scenes containing multiple tools and multiple softbodies. Multiple virtual coupling systems interact with each other through energy consistency constraints.

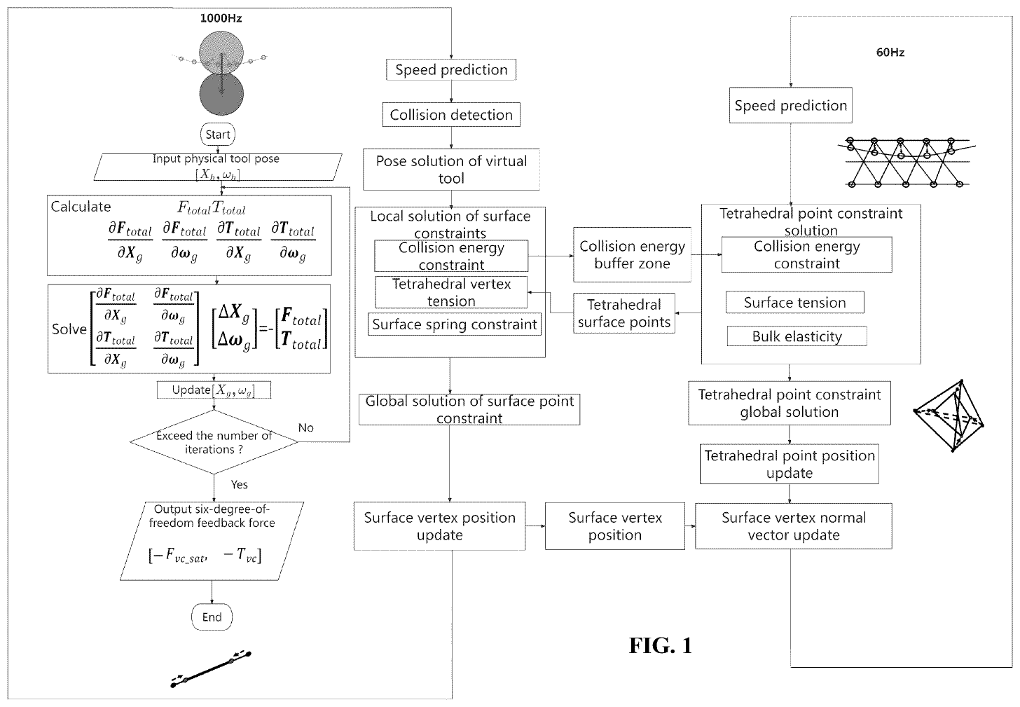

As shown in FIG. 1, a method of haptic rendering via multiple virtual coupling systems with energy consistency, comprises the following steps:
S1, a consistent non-penetration energy consistency constraint between two contacting objects are constructed in a multiple virtual coupling system, comprising:
S11, softbody-to-softbody energy consistency constraint;
there will be a collision interaction between the softbodies, the softbody is represented by a sphere tree, and the collision detection and collision response between the softbodies are performed using the sphere tree, the collision detection will build an energy consistency constraint on the ball on in collision between the softbodies:

$${E}_{ss} = \frac{{w}_{ss}}{2} {‖ {q}_{sphere} - {p}_{sphere} ‖}_{F}^{2} + δ {C}_{css} ( {p}_{sphere} ) \qquad ( 2 )$$

where, Eₛₛ is the constraint energy generated by the collision between the softbodies, wₛₛ is the energy parameter after the collision between the softbodies set by the user, qₛₚₕₑᵣₑ is the center position of the softbody sphere, pₛₚₕₑᵣₑ is the center position of the softbody sphere that just does not collide after projection, and δC_{css}(Pₛₚₕₑᵣₑ) is the indicator function of the collision between the softbodies; when Pₛₚₕₑᵣₑ completely does not contact with qₛₚₕₑᵣₑ, the value is 0; otherwise, the value of the indicator function is infinite. Minimizing this energy can reduce the penetration between the softbodies in the simulation system.

In the softbody model organized by the sphere tree, each sphere tree node contains multiple softbody vertices, and the collision energy on the sphere tree node is evenly distributed to the tetrahedral vertices contained in the sphere tree node, which is expressed by the following formula:

$${E}_{ctv} = {E}_{ss} / {n}_{tv} \qquad ( 3 )$$

where, E_{ctv} is the collision energy on the sphere tree node allocated on the tetrahedral vertices contained in the sphere tree node, and nnₜᵥ is the number of tetrahedral vertices contained in the current sphere tree node.
S12, tool-to-tool energy consistency constraint;
the tool interacts with the tool through collision, after the position overlap between the two virtual tools, the energy constraint between the virtual tools is constructed

$${E}_{tt} = \frac{{w}_{tt}}{2} {‖ {X}_{g} - {X}_{pg} ‖}_{F}^{2} + δ {C}_{ctt} ( {X}_{pg} ) \qquad ( 4 )$$

where, Eₜₜ is the constraint energy generated by the collision between the virtual tools, wₜₜ is the energy parameter after the collision between the virtual tools set by the user, X_{g} is the current position of the virtual tool, X_{pg} is the position of the virtual tool that does not collide with the tool after projection, and δC_{ctt}(X_{pg}) is the indicator function of the collision between the tools, when the projected virtual tool pose X_{pg} does not collide with the current virtual tool, the value is 0, otherwise the value of the indicator function is infinite. Minimizing this energy can handle the penetration between virtual tools in the simulation space.

S13, the energy consistency constraint between the tool and the softbody is used to perform collision detection between the virtual tool and the surface vertex, two kinds of energy are defined on the virtual tool: softbody non-penetration energy and virtual coupling energy.

Based on the consistency between the non-penetration energy of the softbody and the collision energy on the softbody at the deformation end of the softbody, the collision energy of the haptic feedback end is applied to the deformation end of the softbody without loss.

Based on the consistency between the non-penetration energy defined on the virtual tool and the collision energy at the soft deformation end, the non-penetration energy generated by the haptic feedback end is transferred to the soft deformation end without loss, so that the two types of collision detection that should be performed at the soft deformation end can be canceled, the computational redundant is diminished, and the computational efficiency is improved.

By solving the energy constraints of the two energies defined on the virtual tool, the position of the virtual tool can be updated to minimize the energy on the virtual tool. Specifically:
S131, energy consistent softbody and tool haptic feedback interaction;
the energy consistent softbody and tool haptic feedback interaction scheme comprises the energy generated by position intersect in softbody deformation, which is expressed as:

$${E}_{cst} = \frac{{w}_{c}}{2} {‖ q - p ‖}_{F}^{2} + δ {C}_{cst} ( p ) \qquad ( 5 )$$

where, w_{c} represents the stiffness coefficient of non-penetration constraint set by the user the energy constraint, and the constraint C_{cst} is the collision constraint between the virtual softbody vertex and the virtual tool, the condition of satisfying the constraint is that the softbody vertex and the virtual tool do not intersect in space, p is the projected position of the vertex q that satisfies the constraint C_{cst}, and δC_{cst}(p) is the indicator function of softbody vertex p that satisfy the non-penetration constraint, when p satisfies the constraint, the indicator function value is 0; otherwise, the function value is infinite.

S132, non-penetration energy on the virtual tool resulting from the intersection of the softbody vertex with the virtual tool position;
the non-penetration constraint energy is represented by the following formula:

$${E}_{cst} = {\sum }_{i} \frac{{w}_{c}^{i}}{2} {‖ {X}_{g} - {X}_{pg}^{i} ‖}_{F}^{2} + δ {C}_{cst} ( {X}_{pg}^{i} ) \qquad ( 6 )$$

where, X_{g} is the position of the virtual tool,

$${X}_{p g}^{i}$$

is the position of the virtual tool that is not collided with the vertex i after the projection of the position of the virtual tool, and

$$δ {C}_{c t s} ( {X}_{p g}^{i} )$$

is the indicator function of the projected virtual tool, when

$${X}_{pg}^{i}$$

does not contact the vertex, the value of the indicator function is 0; otherwise, the function value is infinite.

The non-penetration energy on the virtual tool is formally consistent with the non-penetration energy in the softbody deformation, this energy consistency is used to construct the connection between the softbody deformation end and the haptic feedback end by sharing of collision information.

S2, the total constraint energy on the virtual tool is calculated to update the virtual tool pose, and a six-degree-of-freedom feedback force is calculated and output via using the updated virtual tool pose;
the total constraint energy on the virtual tool updates the virtual tool pose calculation comprises the following steps:
the virtual coupling energy on the virtual tool is expressed by the following formula:

$${E}_{vc \_ sat} = \frac{{w}_{vc}}{2} {‖ re ‖}_{F}^{2} \qquad ( 7 )$$

$$where$$

$$\begin{matrix}{d}_{vc} = ‖ {X}_{h} - {X}_{g} ‖ \\ e = \frac{{X}_{h} - {X}_{g}}{{d}_{vc}}\end{matrix}$$

$$r = \{ \begin{matrix}{k}_{vc} {d}_{vc} , & if {d}_{vc} < {d}_{lin} \\ {F}_{VC \_ MAX} ( 1 - \frac{1}{2} {e}^{\frac{2 {k}_{vc} ( d - d )}{{F}_{VC \_ MAX}}} ) , & otherwise\end{matrix} \qquad ( 8 )$$

where, w_{vc} is the virtual coupling weight set by the user, d_{vc} is the distance between the virtual tool and the physical tool, r is the size of the virtual coupling force on the tool, e is the unit vector from the virtual tool to the physical tool, dₗᵢₙ is the interval of the linear change of the virtual coupling force set by the user, Xₕ is the position of the physical tool, F_{VC_MAX} is the maximum virtual coupling force intensity set by the user, k_{vc} is the coefficient of the virtual coupling force set by the user, according to the three kinds of energy defined on the virtual tool, the total constraint energy E on the virtual tool, update the virtual tool pose:

$$E = {E}_{vc \_ sat} + {E}_{cts} + {E}_{tt} \qquad ( 9 )$$

the updated virtual tool pose is used to calculate and output the six-degree-of-freedom feedback force, the pose of the virtual tool is expressed as [X_{g}, ω_{g}] and the pose of the physical tool is expressed as [Xₕ, ωₕ]. comprising the following steps:
the position difference between the virtual tool and the physical tool is used to calculate the output feedback force, the calculation formula of the feedback force is as follows:

$${F}_{out} = \{ \begin{matrix}{k}_{vc} ( {X}_{h} - {X}_{g} ) , & if ‖ {X}_{h} - {X}_{g} ‖ < {d}_{lin} \\ \frac{{F}_{VC \_ MAX}}{{d}_{vc}} ( 1 - \frac{1}{2} {e}^{\frac{2 {k}_{vc} ( {d}_{lin} - {d}_{vc} )}{{F}_{VC \_ MAX}}} ) , & otherwise\end{matrix} \qquad ( 10 )$$

where, k_{vc} is the virtual coupling stiffness coefficient set by the user, F_{VC_MAX}; is the maximum output force of the haptic feedback device, dₗᵢₙ is the threshold of the linear change of the feedback force, and d_{vc}=∥Xₕ−X_{g}∥ is the distance between the virtual tool and the physical tool.

The pose difference between the virtual tool and the physical tool is used to calculate the output feedback torque, the feedback torque is calculated as follows:

$${T}_{out} = vec ( {q}_{h} {{q}_{s}}^{- 1} ) \qquad ( 11 )$$

where, qₕ is the quaternion representation of the current physical tool pose, q_{g} is the quaternion representation of the current virtual tool pose, and vec(·) is the function of extracting the imaginary part of the quaternion, finally, the calculated feedback force Fₒᵤₜand feedback torque Tₒᵤₜ are output to the haptic feedback device.

The pose of the virtual tool is updated by the total energy constraint obtained by step S2, and the updated virtual tool pose is used to calculate the feedback force and feedback torque output to the haptic feedback device.

The first item X of the tool pose is the position of the tool, and the second item ω is the pose of the tool, the pose of the virtual tool is updated by the moment balance constraint on the virtual tool, the sum of the resultant force Fₜₒₜₐₗ acting on the virtual tool and the torque Tₜₒₜₐₗ on the virtual tool is specified as

$$\begin{matrix}{F}_{total} = {F}_{c} + {F}_{vc \_ sat} + {F}_{tt} \\ {T}_{total} = {T}_{c} + {T}_{vc} + {T}_{tt}\end{matrix} \qquad ( 12 )$$

where, F_{c} is the contact force generated by the collision between the virtual tool and the virtual softbody, F_{vc_sat} is the virtual coupling force on the virtual tool,

$${F}_{tt} = - \frac{\partial {E}_{tt}}{\partial {X}_{g}}$$

is the contact force generated by the collision between the virtual tools, T_{c} is the contact force torque generated by the collision between the virtual tool and the virtual softbody, T_{vc} is the torque generated by the virtual coupling force, Tₜₜ=t×Fₜₜ is the contact torque generated by the collision between the virtual tools, tis the vector of the grasping point on the virtual tool pointing to the collision point;
because the force on the virtual tool is balanced, the total torque is also balanced, so the optimization goal is:

$${F}_{total}^{new} = {F}_{total} + \frac{\partial {F}_{total}}{\partial {X}_{g}} Δ {X}_{g} + \frac{\partial {F}_{total}}{\partial {ω}_{g}} Δ {ω}_{g} = 0 \qquad ( 13 )$$

$${T}_{total}^{new} = {T}_{total} + \frac{\partial {T}_{total}}{\partial {X}_{g}} Δ {X}_{g} + \frac{\partial {T}_{total}}{\partial {ω}_{g}} Δ {ω}_{g} = 0$$

$$where , {F}_{toatal}^{new}$$

where,

$${F}_{total}^{new}$$

is the resultant force of the virtual coupling force and the contact force on the updated virtual tool,

$${T}_{total}^{new}$$

is the resultant torque of virtual coupling moment and contact torque on the updated virtual tool,

$$\frac{\partial {F}_{total}}{\partial {X}_{g}}$$

is the gradient of the resultant force on the virtual tool at the current virtual tool position,

$$\frac{\partial {F}_{t o t a l}}{\partial {ω}_{g}}$$

is the gradient of the resultant force on the virtual tool at the current virtual tool attitude,

$$\frac{\partial {T}_{t o t a l}}{\partial {X}_{g}}$$

is the gradient of the resultant torque on the virtual tool at the current virtual tool position,

$$\frac{\partial {T}_{t o t a l}}{\partial {ω}_{g}}$$

is the gradient of the resultant torque on the virtual tool at the current virtual tool attitude;
here, to satisfy the force balance and torque balance constraints on the virtual tool, the resultant total force and resultant total torque as optimization objectives are 0;
where, the process of solving the pose update of the virtual tool using the Newton method is expressed by the following formula:

$$[ \begin{matrix}\frac{\partial {F}_{total}}{\partial {X}_{g}} & \frac{\partial {F}_{total}}{\partial {ω}_{g}} \\ \frac{\partial {T}_{total}}{\partial {X}_{g}} & \frac{\partial {T}_{total}}{\partial {ω}_{g}}\end{matrix} ] [ \begin{matrix}Δ {X}_{g} \\ {Δ ω}_{g}\end{matrix} ] = - [ \begin{matrix}{F}_{total} \\ {T}_{total}\end{matrix} ] \qquad ( 14 )$$

solving the system of equations in formula (14) to obtain

$$[ \begin{matrix}Δ {X}_{g} \\ {Δ ω}_{g}\end{matrix} ]$$

for updating the pose of the current virtual tool, where,

$$\frac{\partial {F}_{total}}{\partial {X}_{g}} = ( \frac{{\partial }^{2} E \text{?}}{\partial {X}_{g}^{2}} + \frac{{\partial }^{2} E \text{?}}{\partial {X}_{g}^{2}} + \frac{{\partial }^{2} {E}_{tt}}{\partial {X}_{g}^{2}} ) \qquad ( 15 )$$

$$\frac{\partial {F}_{total}}{\partial {ω}_{g}} = \frac{\partial F \text{?}}{\partial {ω}_{g}} + \frac{\partial {F}_{c}}{\partial {ω}_{g}} - \frac{{\partial }^{2} {E}_{tt}}{\partial {ω}_{g}^{2}}$$

$$\frac{\partial {T}_{total}}{\partial {X}_{g}} = \frac{\partial T \text{?}}{\partial {X}_{g}} + \frac{\partial {T}_{c}}{\partial {X}_{g}} + \frac{\partial {T}_{tt}}{\partial {X}_{g}}$$

$$\frac{\partial {F}_{total}}{\partial {ω}_{g}} = \frac{\partial T \text{?}}{\partial {ω}_{g}} + \frac{\partial {T}_{c}}{\partial {ω}_{g}} + \frac{\partial {T}_{tt}}{\partial {ω}_{g}}$$

$$\text{?} \text{indicates text missing or illegible when filed}$$

after solving (14), the pose of the virtual tool is updated:

$${X}_{g}^{new} ← {X}_{g} + Δ {X}_{g} \qquad ( 16 )$$

$${ω}_{g}^{new} ← update ( {ω}_{g} , {Δ ω}_{g} )$$

$${X}_{g} ← {w X}_{g} + ( 1 - w ) {X}_{g}^{new}$$

$${ω}_{g} ← {w X}_{g} + ( 1 - w ) {ω}_{g}^{new}$$

$$where , {X}_{g}^{new}$$

where,

$${X}_{g}^{n e w}$$

is the position of the virtual tool updated by Newton method, update( [symbol] ) is the function of updating the tool pose according to the pose change,

$${ω}_{g}^{n e w}$$

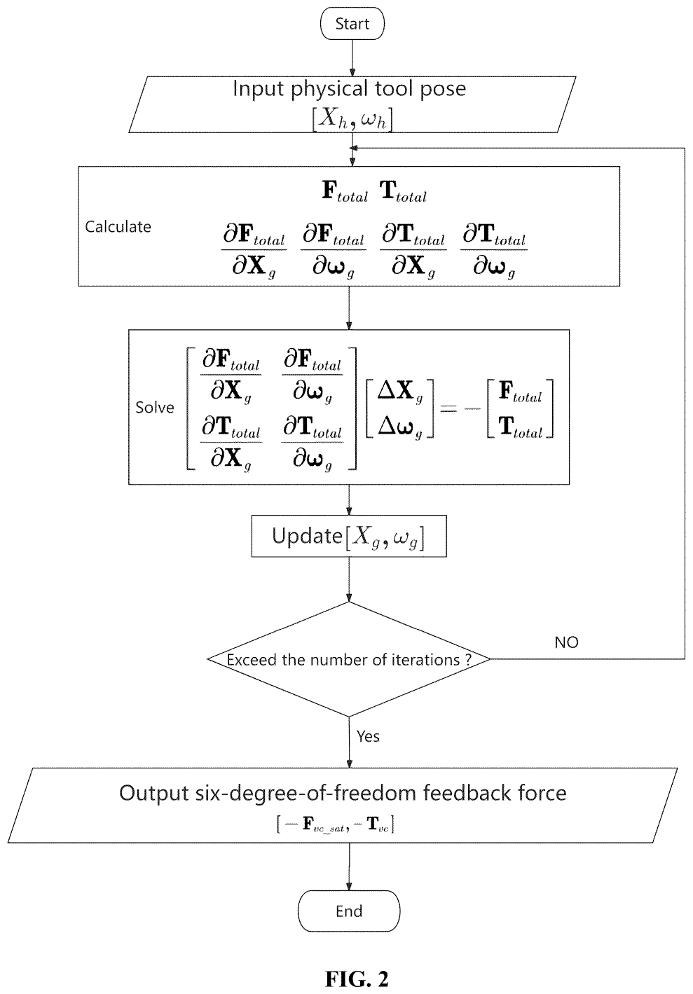

is the updated virtual tool pose, and w∈[0,1) is the weight of the pose in the last iteration, when the number of iterations exceeds the number set by the user, jump out of the loop and output the six-degree-of-freedom feedback force [−F_{vc_sat}, −T_{vc}] to the haptic feedback device. The flow chart of the six-degree-of-freedom feedback force calculation is shown in FIG. 2.

S3, a shared storage update strategy is constructed around the collision information about the haptic feedback end, wherein the haptic feedback end is a process set related to feedback force calculation in a haptic feedback interaction algorithm with energy consistent of a multiple virtual coupling system.

An update strategy based on shared memory on GPU is adopted, the softbody deformation end can obtain the latest collision information and update the vertex position of the softbody via sharing memory and accumulating collision information, so that the haptic feedback end can obtain the latest vertex position. In this section, the synchronization method between the two different frequency systems of the haptic feedback end and the softbody deformation end will be introduced. A shared storage update strategy is constructed around the collision information about the haptic feedback end, comprising:
in each haptic feedback frame, collision information is generated on each softbody vertex, this collision information includes the non-penetration constraint energy E_{c} generated by the penetration between the tool and the softbody and the gradient information

$$\frac{{\partial }^{2} {E}_{c}}{\partial {X}_{g}^{2}}$$

generated by the constraint solution., the collision energy and gradient information generated by the collision with the tool on the softbody vertex are expressed as follows:

$${E}_{c} = {{\sum }_{i = 1}}^{p} {E}_{cst}^{i} \qquad ( 17 )$$

$$\frac{{\partial }^{2} {E}_{c}}{\partial {q}^{2}} = - {\sum }_{i = 1}^{p} \frac{{\partial }^{2} {E}_{c s t}}{\partial {X}_{g}^{2}}$$

the non-penetration constraint energy on the softbody vertex is consistent with the non-penetration constraint energy on the virtual tool, but the gradient of the softbody vertex here is opposite to the gradient direction of the virtual tool here;
in the time of processing a softbody deformation frame, several haptic feedback frames may be finished, therefore, the collision information on the vertices of the softbody is accumulated until the softbody deformation end completes its vertex position update, after vertex position update finished, the accumulated collision information on the vertices is emptied. Such an updating strategy can ensure that the softbody deformation end can obtain collision information accumulated by the latest multiple haptic feedback frames. Compared to conventional implementations, the method of the present invention can eliminate the collision detection process at the deformation end of the softbody, thereby speeding up the physical simulation of the softbody at the softbody deformation end. The haptic feedback frame is a loop in the calculation of the haptic feedback end, and ideally, more than 500 haptic feedback frames are executed every second to achieve a stable feedback force output. Each haptic feedback frame calculates a feedback force and a feedback torque according to the method of claim S2 and outputs the feedback force and the feedback torque to the haptic feedback device, and the haptic feedback device updates the output feedback force and feedback torque at a frequency higher than 500 Hz.

And the collision detection of the present invention will be carried out at a frequency of 1000 Hz, compared with the 60 Hz update frequency of the softbody deformation end, the collision signal sampling frequency is higher, and more accurate non-penetration energy can be obtained by integral. The deformation end contains the calculation related to the softbody deformation simulation, including the tetrahedral vertex constraint solution, the tetrahedral vertex position update, and the softbody surface normal vector update. The softbody deformation end iteratively updates the vertex position of the softbody at a frequency of 60 Hz. One iteration is updated to a softbody deformation.

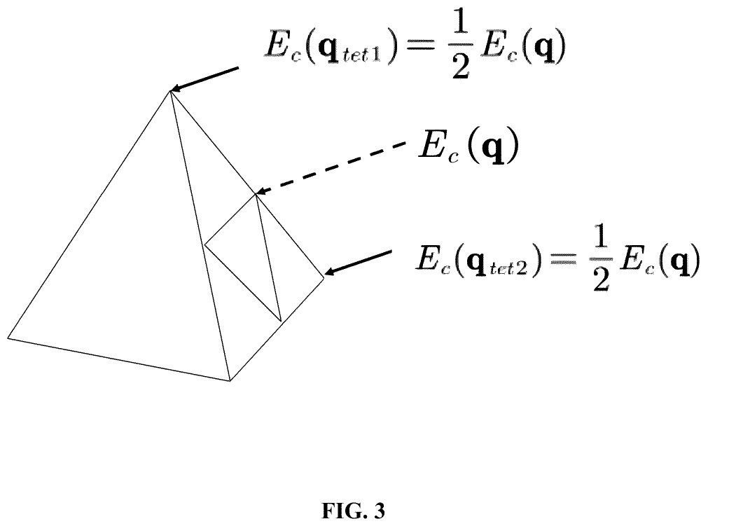

In the modeling method of the present invention, the volume is expressed by tetrahedral mesh, and the surface is expressed by triangular mesh. The triangular mesh of the surface is obtained by surface subdivision of the surface triangular mesh of the tetrahedral mesh. For the vertices that are originally on the surface of the original tetrahedron, the collision energy and gradient are directly accumulated to the corresponding tetrahedron vertices; for the surface vertices subdivided by the surface mesh, the collision energy and the collision gradient are equally divided into the surface mesh vertices corresponding to the subdivided vertices. The schematic diagram of the non-penetration energy average allocation strategy is shown in FIG. 3. Wherein, E_{c}(·) is the non-penetration constraint energy on the applied vertex, q is the surface triangular mesh vertex, qₜₑₜ₁ is the first tetrahedral vertex position bound by the surface triangular vertex q, and qₜₑₜ₂ is the second tetrahedral vertex position bound by the surface triangular vertex q, the non-penetration constraint energy on the surface triangular vertex will be equally divided into two tetrahedral vertices bound by the surface triangular vertex.

Therefore, the present invention adopts the above-mentioned method of haptic rendering via multiple virtual coupling systems with energy consistency, which can process common virtual surgery scenarios in which a tool is inserted into a narrow gap and obtain a stable feedback force output, reduce the computational redundancy between two different frequency systems and improve the computational efficiency by utilizing the consistency of non-penetration energy at the deformation end and the haptic feedback end.

Finally, it should be noted that the above examples are merely used for describing the technical solutions of the present invention, rather than limiting the same. Although the present invention has been described in detail with reference to the preferred examples, those of ordinary skill in the art should understand that the technical solutions of the present invention may still be modified or equivalently replaced. However, these modifications or substitutions should not make the modified technical solutions deviate from the spirit and scope of the technical solutions of the present invention.

What is claimed is:

1. A multiple virtual coupling system, comprising a virtual coupling system of tools and a virtual coupling system of softbodies, the virtual coupling system of tools consists of two parts: virtual tools and physical tools, and the virtual coupling system of softbodies consists of two parts: virtual softbodies and physical softbodies.

2. A method of haptic rendering via multiple virtual coupling systems with energy consistency according to claim 1, comprises the following steps:
S1, in a multiple virtual coupling system, constructing an energy consistency constraint, comprising:
S11, softbody-to-softbody energy consistency constraint;
S12, tool-to-tool energy consistency constraint;
S13, tool-to-softbody energy consistency constraint;
S2, calculating a total constraint energy on the virtual tool to update the virtual tool pose, calculating and outputting a six-degree-of-freedom feedback force using an updated virtual tool pose; and
S3, constructing a shared storage update strategy around the collision information about the haptic feedback end, wherein the haptic feedback end is a process set related to feedback force calculation in a haptic feedback interaction algorithm with energy consistent of a multiple virtual coupling system.

3. The method of haptic rendering via multiple virtual coupling systems with energy consistency according to claim 2, wherein in step S11, there will be a collision interaction between the softbodies, the softbody is represented by a sphere tree, and the collision detection and collision response between the softbody are performed using the sphere tree, the collision detection will build an energy consistency constraint on the ball in collision between the softbodies:
$${E}_{ss} = \frac{{w}_{ss}}{2} {‖ {q}_{sphere} - {p}_{sphere} ‖}_{F}^{2} + δ {C}_{css} ( {p}_{sphere} ) \qquad ( 1 )$$
where, Eₛₛ is a constraint energy generated by the collision between the softbodies, wₛₛ is an energy parameter after the collision between the softbodies set by the user, qₛₚₕₑᵣₑ is a center position of the softbody sphere, Pₛₚₕₑᵣₑ is a center position of the softbody sphere that just does not collide after projection, and δC_{css}(Pₛₚₕₑᵣₑ) is an indicator function of the collision between the softbodies;
in the softbody model organized by the sphere tree, each sphere tree node contains multiple softbody vertices, and the collision energy on the sphere tree node is evenly distributed to the tetrahedral vertices contained in the sphere tree node, which is expressed by the following formula:
$${E}_{ctv} = {E}_{ss} / {n}_{tv} \qquad ( 2 )$$
where, E_{ctv} is a collision energy on the sphere tree node allocated on the tetrahedral vertices contained in the sphere tree node, and nₜᵥ is a number of tetrahedral vertices contained in the current sphere tree node.

4. The method of haptic rendering via multiple virtual coupling systems with energy consistency according to claim 3, wherein in step S12, the tool interacts with the tool through collision, after the position overlap between the two virtual tools, the energy constraint between the virtual tools is constructed
$${E}_{tt} = \frac{{w}_{tt}}{2} {‖ {X}_{g} - {X}_{pg} ‖}_{F}^{2} + δ {C}_{ctt} ( {X}_{pg} ) \qquad ( 3 )$$
where, Eₜₜ is a constraint energy generated by the collision between the virutal tools, wₜₜ is a energy parameter after the collision between the virtual tools set by the user, X_{g} is a current position of the virtual tool, X_{pg} is a position of the virtual tool that does not collide with the tool after projection, and δC_{ctt}(X_{pg}) is an indicator function of the collision between the virtual tools.

5. The method of haptic rendering via multiple virtual coupling systems with energy consistency according to claim 4, wherein in step S13, the energy consistency constraint between the tool and the softbody is used to perform collision detection between the virtual tool and the surface vertex, specifically:
S131, energy consistent softbody and tool haptic feedback interaction;
S132, non-penetration energy on the virtual tool resulting from the intersection of the softbody vertex with the virtual tool position.

6. The method of haptic rendering via multiple virtual coupling systems with energy consistency according to claim 5, wherein in step S131, the energy consistent softbody and tool haptic feedback interaction scheme comprises the energy generated by position intersect in softbody deformation, which is expressed as:
$${E}_{cst} = \frac{{w}_{c}}{2} {‖ q - p ‖}_{F}^{2} + δ {C}_{cst} ( p ) \qquad ( 4 )$$
where, w_{c} represents a stiffness coefficient of non-penetration constraint set by the user, and a constraint C_{cst} is a collision constraint between the virtual softbody vertex and the virtual tool, the condition of satisfying the constraint is that the softbody vertex and the virtual tool do not intersect in space, p is a projected position of the vertex q that satisfies the constraint C_{cst}, and δC_{cst}(p) is an indicator function of softbody vertex p that satisfy the non-penetration constraint.

7. The method of haptic rendering via multiple virtual coupling systems with energy consistency according to claim 6, wherein in step S132, a non-penetration constraint energy is represented by the following formula:
$${E}_{cst} = {\sum }_{i} \frac{{w}_{c}^{i}}{2} {‖ {X}_{g} - {X}_{pg}^{i} ‖}_{F}^{2} + δ {C}_{cts} ( {X}_{pg}^{i} ) \qquad ( 5 )$$
where, X_{g} is a position of the virtual tool,
$${X}_{pg}^{i}$$
is a position of the virtual tool that is not collided with a vertex i after the projection of the position of the virtual tool, and
$$δ {C}_{cts} ( {X}_{pg}^{i} )$$
is an indicator function of the projected virtual tool.

8. The method of haptic rendering via multiple virtual coupling systems with energy consistency according to claim 7, wherein in step S2, the total constraint energy on the virtual tool updates the virtual tool pose calculation comprises the following steps:
the virtual coupling energy on the virtual tool is expressed by the following formula:
$${E}_{vc \_ sat} = \frac{{w}_{vc}}{2} {‖ re ‖}_{F}^{2} \qquad ( 6 )$$
$$where$$
$$\begin{matrix}{d}_{vc} = ‖ {X}_{h} - {X}_{g} ‖ \\ e = \frac{{X}_{h} - {X}_{g}}{{d}_{vc}}\end{matrix} \qquad ( 7 )$$
$$r = \{ \begin{matrix}{k}_{vc} {d}_{vc} , & if {d}_{vc} < {d}_{lin} \\ {F}_{VC \_ MAX} ( 1 - \frac{1}{2} {e}^{\frac{2 {k}_{vc} ( {d}_{vc} - {d}_{lin} )}{{F}_{VC \_ MAX}}} ) , & otherwise\end{matrix}$$
where, w_{vc} is a virtual coupling weight set by the user, d_{vc} is a distance between the virtual tool and the physical tool, r is a size of the virtual coupling force on the tool, e is a unit vector from the virtual tool to the physical tool, dₗᵢₙ is an interval of the linear change of the virtual coupling force set by the user, Xₕ is a position of the physical tool, F_{VC_MAX} is a maximum virtual coupling force intensity set by the user, k_{vc} is a coefficient of the virtual coupling force set by the user, according to the three kinds of energy defined on the virtual tool, the total constraint energy E on the virtual tool, update the virtual tool pose:
$$E = {E}_{vc \_ sat} + {E}_{cst} + {E}_{tt} . \qquad ( 8 )$$

9. The method of haptic rendering via multiple virtual coupling systems with energy consistency according to claim 1, wherein in step S2, the updated virtual tool pose is used to calculate and output the six-degree-of-freedom feedback force, comprising the following steps:
a pose of the virtual tool is expressed as [X_{g}, ω_{g}], and a pose of the physical tool is expressed as [Xₕ, ωₕ] a first item X of the tool pose is the position of the tool, and a second item ω is the pose of the tool, the pose of the virtual tool is updated by the moment balance constraint on the virtual tool, a sum of the resultant force Fₜₒₜₐₗ acting on the virtual tool and a torque Tₜₒₜₐₗ on the virtual tool is specified as
$$\begin{matrix}{F}_{total} = {F}_{c} + {F}_{vc \_ sat} + {F}_{tt} \\ {T}_{total} = {T}_{c} + {T}_{vc} + {T}_{tt}\end{matrix} \qquad ( 9 )$$
where, F_{c} is a contact force generated by the collision between the virtual tool and the virtual softbody, F_{vc_satt} is a virtual coupling force on the virtual tool,
$${F}_{tt} = - \frac{\partial {E}_{tt}}{\partial {X}_{g}}$$
is a contact force generated by the collision between the virtual tools, T_{c} is a contact force torque generated by the collision between the virtual tool and the virtual softbody, T_{vc} is a torque generated by the virtual coupling force, Tₜₜ=t×Eₜₜ is a contact torque generated by the collision between the virtual tools, t is a vector of the grasping point on the virtual tool pointing to the collision point;
because the force on the virtual tool is balanced, the total torque is also balanced, so the optimization goal is:
$$\begin{matrix}{F}_{total}^{new} = {F}_{total} + \frac{\partial {F}_{total}}{\partial {X}_{g}} Δ {X}_{g} + \frac{\partial {F}_{total}}{\partial {ω}_{g}} {Δω}_{g} = 0 \\ {T}_{total}^{new} = {T}_{total} + \frac{\partial {T}_{total}}{\partial {X}_{g}} Δ {X}_{g} + \frac{\partial {T}_{total}}{\partial {ω}_{g}} {Δω}_{g} = 0\end{matrix} \qquad ( 10 )$$
where,
$${F}_{toatal}^{new}$$
is a resultant force of the virtual coupling force and the contact force on the updated virtual tool,
$${T}_{total}^{new}$$
is a resultant torque of virtual coupling moment and contact torque on the updated virtual tool,
$$\frac{\partial {F}_{total}}{\partial {X}_{g}}$$
is a gradient of the resultant force on the virtual tool at the current virtual tool position,
$$\frac{\partial {F}_{total}}{\partial {ω}_{g}}$$
is a gradient of the resultant force on the virtual tool at the current virtual tool attitude,
$$\frac{\partial {T}_{total}}{\partial {X}_{g}}$$
is a gradient of the resultant torque on the virtual tool at the current virtual tool position,
$$\frac{\partial {T}_{total}}{\partial {ω}_{g}}$$
is a gradient of the resultant torque on the virtual tool at the current virtual tool attitude;
here, to satisfy the force balance and torque balance constraints on the virtual tool, the resultant total force and resultant total torque as optimization objectives are 0;
where, the process of solving the pose update of the virtual tool using the Newton method is expressed by the following formula:
$$[ \begin{matrix}\frac{\partial {F}_{total}}{\partial {X}_{g}} & \frac{\partial {F}_{total}}{\partial {ω}_{g}} \\ \frac{\partial {T}_{total}}{\partial {X}_{g}} & \frac{\partial {T}_{total}}{\partial {ω}_{g}}\end{matrix} ] [ \begin{matrix}Δ {X}_{g} \\ {Δω}_{g}\end{matrix} ] = - [ \begin{matrix}{F}_{total} \\ {T}_{total}\end{matrix} ] \qquad ( 11 )$$
solving the system of equations in formula (11) to obtain
$$[ \begin{matrix}Δ {X}_{g} \\ {Δω}_{g}\end{matrix} ]$$
for updating the pose of the current virtual tool, where,
$$\frac{\partial {F}_{total}}{\partial {X}_{g}} = - ( \frac{{\partial }^{2} {E}_{vc \_ sat}}{\partial {X}_{g}^{2}} + \frac{{\partial }^{2} {E}_{cts}}{\partial {X}_{g}^{2}} + \frac{{\partial }^{2} {E}_{tt}}{\partial {X}_{g}^{2}} ) \qquad ( 12 )$$
$$\frac{\partial {F}_{total}}{\partial {ω}_{g}} = \frac{\partial {F}_{vc \_ sat}}{\partial {ω}_{g}} + \frac{\partial {F}_{c}}{\partial {ω}_{g}} - \frac{{\partial }^{2} {E}_{tt}}{\partial {ω}_{g}^{2}}$$
$$\frac{\partial {T}_{total}}{\partial {X}_{g}} = \frac{\partial {T}_{vc}}{\partial {X}_{g}} + \frac{\partial {T}_{c}}{\partial {X}_{g}} + \frac{\partial {T}_{tt}}{\partial {X}_{g}}$$
$$\frac{\partial {T}_{total}}{\partial {ω}_{g}} = \frac{\partial {T}_{vc}}{\partial {ω}_{g}} + \frac{\partial {T}_{c}}{\partial {ω}_{g}} + \frac{\partial {T}_{tt}}{\partial {ω}_{g}}$$
after solving (11), the pose of the virtual tool is updated:
$${X}_{g}^{new} ← {X}_{g} + Δ {X}_{g} \qquad ( 13 )$$
$${ω}_{g}^{new} ← update ( {ω}_{g} , {Δω}_{g} )$$
$${X}_{g} ← {wX}_{g} + ( 1 - w ) {X}_{g}^{new}$$
$${ω}_{g} ← w {ω}_{g} + ( 1 - w ) {ω}_{g}^{new}$$
where,
$${X}_{g}^{new}$$
is a position of the virtual tool updated by Newton method, update( [symbol] ) is a function of updating the tool pose according to the pose change,
$${ω}_{g}^{new}$$
is the updated virtual tool pose, and w∈[0,1) is a weight of the pose in the last iteration, when the number of iterations exceeds the number set by the user, jump out of the loop and output the six-degree-of-freedom feedback force [−F_{vc_sat}, −T_{vc}] to the haptic feedback device.

10. The method of haptic rendering via multiple virtual coupling systems with energy consistency according to claim 9, wherein in step S3, constructing a shared storage update strategy around the collision information about the haptic feedback end, comprising:
in each haptic feedback frame, collision information is generated on each softbody vertex, this collision information includes the non-penetration constraint energy E_{c} generated by the penetration between the tool and the softbody and a gradient information
$$\frac{{\partial }^{2} {E}_{c}}{\partial {X}_{g}^{2}}$$
generated by the constraint solution, the collision energy and gradient information generated by the collision with the tool on the softbody vertex are expressed as follows:
$${E}_{c} = {\sum }_{i = 1}^{p} {E}_{cst}^{i} \qquad ( 14 )$$
$$\frac{{\partial }^{2} {E}_{c}}{\partial {q}^{2}} = - {\sum }_{i = 1}^{p} \frac{{\partial }^{2} {E}_{cst}}{\partial {X}_{g}^{2}}$$
the non-penetration constraint energy on the softbody vertex is consistent with the non-penetration constraint energy on the virtual tool, but the gradient of the softbody vertex here is opposite to the gradient direction of the virtual tool here;
in the time of processing a softbody deformation frame, several haptic feedback frames may be finished, therefore, the collision information on the vertices of the softbody is accumulated until the softbody deformation end completes its vertex position update, after vertex position update finished, the accumulated collision information on the vertices is emptied.
